(19) United States
(12) Patent Application Publication
(10) Pub. No.: US 2002/0151359 A1
(43) Pub. Date: Oct. 17, 2002

(54) Player account access and management system

(76) Inventor: Richard Rowe, Reno, NV (US)

Correspondence Address: R. Scott Weide, Weide & Miller, Ltd., 11th Floor, Suite 1130, 330 S. 3rd Street, Las Vegas, NV, 89101, US

(21) Appl. No.: 10/099,152

(22) Filed: Mar. 14, 2002

Related U.S. Application Data
(60) Provisional application No. 60/276,790, filed on Mar. 15, 2001.

(51) Int. Cl. G06F 19/00

(52) U.S. Cl. 463/29

(57) ABSTRACT

A system and method for player account access and management is disclosed. The system includes a player tracking or reward system in which player activity is tracked and points or credits are awarded and associated with a player's account. The system includes a remote player device and a communication link established between the remote device and the player tracking or reward system. Using the link, a player is permitted to access player account information such as accumulated points or credits and criteria for obtaining rewards. In one embodiment, a plurality of player tracking or reward systems are associated with a player access station. The multiple player tracking or reward systems may be associated with different entities. The player access station provides account information regarding each of the player's accounts.

### RELATED APPLICATION DATA

This application claims priority to U.S. Provisional Application Serial No. 60/276,790 under 35 U.S.C. §120.

### FIELD OF THE INVENTION

The present invention relates to player or customer accounts such as those which reward customers for engaging in activities such as purchases or game play, and more particularly to a system for accessing and managing these accounts.

### BACKGROUND OF THE INVENTION

Businesses often attempt to establish customer loyalty at least in part by rewarding customers for their business. Grocery stores and similar business may reward customers discounts, free products or other awards based upon the customer's level of purchases at the store. Similarly, gaming operators often reward players with awards for their level of play of games. For example, a casino may reward or “comp” a player based on the level of betting or game play by the player. The reward may be free game play, a free night of lodging, food or other awards.

Commonly, whether a player is entitled to an award is based upon the points which are awarded to the player based upon activities which the player engages in. In the case of a grocery store, points may be awarded based upon dollars expended by the customer. In the case of a casino, the points may be awarded based upon dollars wagered. Of course, a wide variety of criteria may be employed for determining how points are assigned and awarded.

In order to participate in the reward program, a customer or player normally fills out an entry sheet at the business or casino. The business generates a customer account, associates the customer's information with the account and assigns the customer an identifier. The identifier may comprise a coded card including a unique identification code or number. When the customer engages in a transaction with the business, the player provides their identifier, such as by swiping their card. The customer's activities are monitored and the customer's account updated based on those activities. For example, the player's account may be credited one point for each dollar spent at a grocery store or for each dollar bet while playing a game.

The business may post signs or provide brochures indicating awards which are available to the player for levels of points or participation. In some instances, a player may automatically be awarded a reward when a point level is achieved. This may be accomplished by having a computer scan the businesses' customer accounts to determine which accounts have sufficient associated points. In another arrangement, a player may continue to aggregate points until the player has reached a desired prize level. The player may then travel to the business and request redemption of the points in the account for the reward.

Unfortunately, a player's knowledge of their point total and the points necessary for a reward is limited. In some instances, a player may only be provided information regarding their point total when engaging in another transaction at the business. In other instances, the business may periodically mail a flyer to the player indicating the players point total at a particular time.

A significant problem with these player reward programs is that generally only the business has satisfactory access to the data. The business develops a detailed database regarding the identity of the player and their activities, including point or other reward status totals, which information is always readily available to the business. On the other hand, the player generally has very limited access to information regarding their activities and point totals relative to rewards available.

Unfortunately, the player's limited information regarding their reward account may counter-act the purpose of the account. When a player is not aware that they are approaching a reward category, the player's level of desire to make purchases at the business or play a game at a particular casino may not be as high as when the player is aware of an impending award.

A system and method which permits a player to access player account information and manage that information is desired.

### SUMMARY OF THE INVENTION

The present invention comprise a system and method permitting player account access and management.

In one embodiment, a player account access and management system is provided which includes a player tracking system. The player tracking system includes a computing device which generates player activity data or receives the data from a remote source. The computing device generates player account information. This information is stored in a player account file in an associated database. In one embodiment, the player tracking system includes at least one gaming device which generates player activity information, such as wager values. The computing device of the player tracking system utilizes this information to generate player point information which is associated with the account. In a preferred embodiment, the player tracking system is arranged as a reward system in which a player is awarded a reward for achieving certain point or credit totals.

In one embodiment, the player account access and management system includes a remote player device. This device may comprise a computer.

A communication interface is associated with the player tracking system. In one embodiment, the communication interface is associated directly with the computing device. In another embodiment, the interface may be associated with a server which is in communication with the computing device. The interface permits two-way communication to and from the player tracking system and a remote location. Similarly, the remote player device includes a communication interface.

In accordance with the invention, a communication link is established between the remote player device and the player tracking system. Via this link, player account information is provided to the player. In addition, via this communication link a player may engage in a variety of account related activities, such as establishing an account and managing an account. A player is permitted to change account information, such as identification information. A player is permitted to view point totals which the player has accumulated and the criteria (such as number of points) for establishing entitlement to a reward. A player may also be permitted to redeem points for an award, including changing the points into other types of credits, such as miles or monetary credit for use in receiving other types of awards or purchasing goods and/or services.

In another embodiment of the invention, a player access station is associated with the player tracking system. Player account information is provided to the player access station from the player tracking system. This information may be forwarded via a communication link such as a dedicated pathway or the Internet. In this embodiment, a communication link is established between the remote player station and the player access system. The player access station provides account information to the player and enables account management. Updated player account information based on player activities is provided from the player access station to the player tracking system.

In another embodiment of the invention, a plurality of player tracking or reward systems are associated with one or more player access stations. The individual player tracking or reward systems may be associated with different entities, such as different casinos or casino properties. Information regarding a player's accounts associated with each system is forwarded to the player access station. By accessing the player access station, a player may obtain player account information regarding several accounts, including simultaneously displayed information. The player access station also facilitates player account management by the player as to any of the accounts.

In this embodiment, a player may be permitted to move points or credits from one account to another, merge points, and manipulate points or credits from one type to another.

Other aspects of the invention comprise methods ofaccessing and managing accounts, such as by using a player account access and management system. In one embodiment, information is provided to a player without the player accessing the player access station or player tracking system. In one embodiment, the player tracking system or player access station is arranged to generate email messages containing account and other information which is transmitted to the player, such as a player's email account.

Further objects, features, and advantages of the present invention over the prior art will become apparent from the detailed description of the drawings which follows, when considered with the attached figures.

### DESCRIPTION OF THE DRAWINGS

FIG. 1 illustrates a player account access and management system in accordance with one embodiment of the invention; and

FIG. 2 illustrates a player account access and management system in accordance with another embodiment of the invention.

### DETAILED DESCRIPTION OF THE INVENTION

The invention is a system and method for providing access and management of player accounts. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One or more embodiments of the invention comprise a player account access and management system. Other embodiments of the invention comprise methods of accessing and managing such accounts.

In the description below exemplary embodiments will be described with reference to accounts associated with casino or other game play reward systems. In such embodiments, the accounts are associated with “players” and activities such as gaming machine play. It will be appreciated that the present invention may be adapted to be used in a wide variety of settings and industries, such as other businesses providing goods or services. In such event, the accounts may be associated with what are referred to as “customers,” although it will be appreciated that the principles of the invention remain the same.

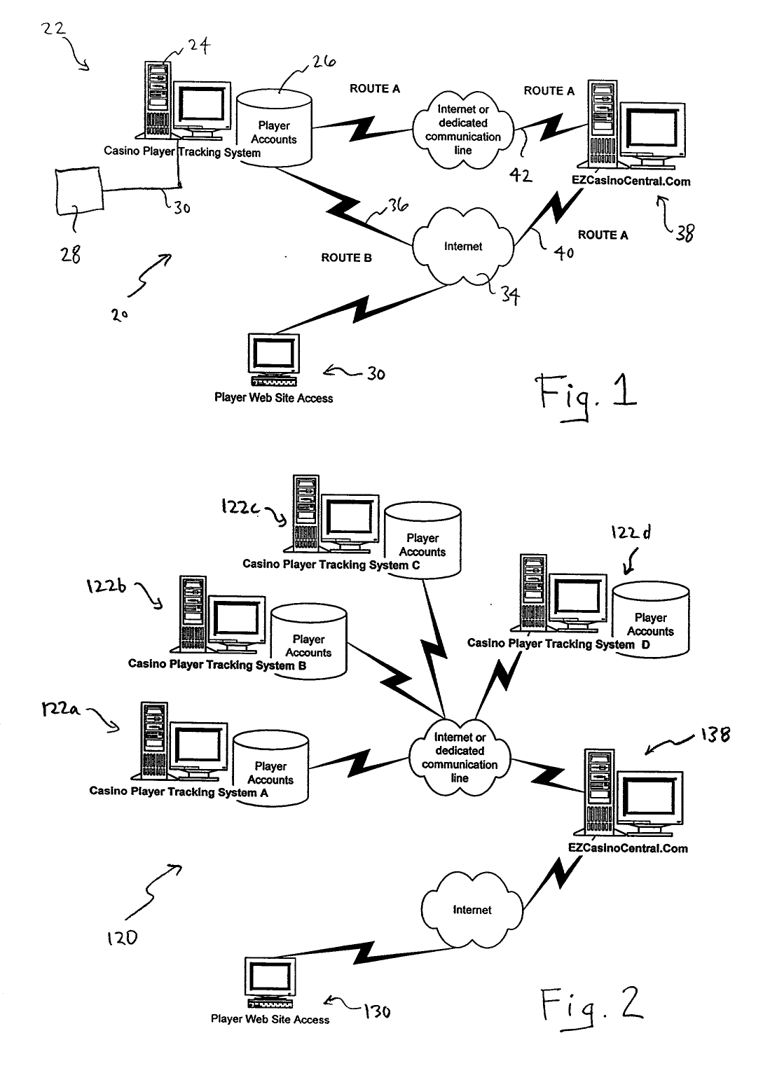

Referring to FIG. 1 there is illustrated a system in accordance with one embodiment of the invention. In this embodiment a player account access and management system 20 is provided. In general, the player account access and management system 20 includes a player tracking system 22. The player tracking system 22 may have a variety of configurations. In one embodiment, the player tracking system 22 includes a computing device 24 and an associated database 26. The computing device 24 is arranged to perform various functions based on provided instructions, and may comprise a processing device executing software code. The database 26 comprises a data storage or “memory” device, and more preferably a data mass storage device. The data storage device may comprise a hard drive, CD-ROM with read/write capabilities or a wide variety of devices now known or later developed.

In general, the computing device 24 is arranged to generate player accounts, such as in the form of one or more data files, which are stored at the database 26. The computing device 24 is also arranged to update the player's account information to the database 26.

In the case of a casino, one or more gaming machines 28 are associated with the player tracking system 22. The gaming machines 28 may be of a variety of types. Regardless, player activities associated with the one or more gaming machines 28 are tracked or monitored. In one embodiment, activity data is provided from the gaming machine 28 to the computing device 24 via a communications link. This link may comprise a wired or wireless communications link.

In one or more embodiments, when a player plays a game at the gaming machine 28, the player identifies themselves, such as by swiping a player tracking card. A player identifier stored on the card is read by a card reader (not shown) of the gaming machine 28 and is sent to the computing device 24. Game play information, such as amounts bet or won, is forwarded from the gaming machine 28 to the computing device 24. The computing device 24 utilizes the player information to update the player's account, such as by incrementing additional points to the account based on the player's play. As noted above, the criteria for awarding points may vary. In some instances, the casino may award points based upon length of time of play, or even factors not associated directly with the play of the gaming machine 28.

A wide variety of information may be generated and then stored at the database 26, including information regarding the player and the player's activities, such as time of play, type of machine played, and even play strategies. In one or more embodiments, this information is used to determine rewards or awards to which the player is entitled. In one embodiment, a player may be entitled to a reward based upon accumulated points.

In accordance with the invention, the player account access and management system 20 includes one or more means by which a player may access their account information and in one or more embodiments, manage or manipulate the account information. In a preferred embodiment of the invention, a player is permitted to gain access to their account information from a remote computing device 30.

The remote computing device 30 may be a variety of devices. In one embodiment the remote computing device 30 comprises a computer. The computer includes a processing device, a bus, and at least one memory or data storage device. The computer includes a display for displaying information to the user. A keyboard or other input device may be associated with the computer to allow a user to provide input. It will be appreciate that depending on how the player account access and management system 20 is implemented, the remote computing device 30 may be a “dumb” device, and comprise simply an input/output device with little or no computing capability. The computing device 30 may include devices known as “personal assistants” or PDAs, cell phones, and other devices capable of establishing a communication link (as detailed below) and provide input and output.

In a preferred embodiment, the remote computing device 30 includes a communication interface. In one embodiment, the interface is associated with the bus of the computing device. The interface may implement a wide variety of architectures/protocols. For example, the interface may be adapted to implement a wireless Bluetooth or IEEE 802.11(b) protocol/architecture or a wired IEEE-1394 or Ethernet protocol/architecture.

In one embodiment, the communication interface provides two-way communication coupling via a network link 32 to a network or other device. In one embodiment, the network link 32 provides a connection to an Internet Service Provider (ISP). The ISP in turn provides data communication services through a world wide packet data communication network now commonly referred to as the “Internet” 34. The configuration/architecture of the Internet and its method of operation is well known.

In one embodiment of the invention, the player tracking system 22 also includes a communication interface for permitting two-way data communication. Again, this interface may be of a variety of types and employ a variety of architectures/protocols. In one embodiment, a communications gateway may be provided between the player tracking system 22 and one or more outside networks. This gateway may include a server for receiving and transmitting information and include data manipulating hardware and software, such as for converting data from one form to another to provide a data interface between devices utilizing different communication protocols.

Preferably, the communications interface of the player tracking system 22 permits data communication with the system 22 from the outside via a network link 36. This link 36 may provide a connection to an ISP or otherwise to the Internet 34. Of course, the player tracking system 22 may be associated with a local area network or LAN including one or more associated devices, such as casino operation terminals and the gaming machines 28.

In accordance with the present invention, a player may access information associated with the player tracking system 22 via the Internet 34, such as by the network links 32. In one embodiment, the computing device 24 of the player tracking system 22 may be arranged to provide menus or other navigation/instruction information to a player accessing the player tracking system. The provided information may comprise a graphical user interface which is uploaded to the player's remote computing device 30. Preferably, the graphical user interface is adapted to provide instructions to the player/user regarding the types of transactions which the player may perform in association with the player tracking system 22 and/or the types of information which the player may access.

In one or more embodiments, the player is permitted to access a wide variety of information. This information may comprise the player's identification information, such as name, address or the like. The information may also comprise the player's accumulated points or other types of information assigned to the account by the casino regarding the player's play and/or entitlement to an award.

The accessible information may also include details regarding the casino's player reward program, including the terms and conditions thereof. The information may include details regarding the requisites for qualifying for one or more awards. For example, in the event the casino employs a reward program where various prizes are awarded for levels of points (such as a first prize for a first minimum number of points, another prize for a higher minimum number of points, etc.), then information regarding the number of points necessary for particular plateaus or prizes may be detailed. In this manner, a player may determine their eligibility for a particular prize, or the level of additional points (and thus associated play) which may be necessary to qualify for that prize.

In one or more embodiments, the information may include details regarding how points are received. The information may also detail when points were previously awarded. Such information is useful to a player in identifying how to receive additional points, such as when a player is attempting to achieve a higher number of points to reach a prize level.

In one or more embodiments, a player is permitted to manage their player account. This may comprise changing personal information. In one or more embodiments, a player may also be permitted to redeem points for one or more prizes, depending on the particular criteria. For example, in one embodiment of the invention a player may be permitted to exchange accumulated points for one or more prizes or rewards.

A variety of methods may be provided for redeeming a prize. In one embodiment, a player may indicate a particular prize which they wish to redeem their points for. The identification may be by a prize number or the like. Once the prize has been redeemed, the player's point total is reduced.

In one or more embodiments, a new player may be permitted to enroll in the player reward program. In this embodiment, upon selection of a particular option, and enrollment form may be displayed to the player and the player may input appropriate data to establish a player account. In another embodiment, a player may change the status of their enrollment, including deactivating or merging accounts.

In one or more embodiments, a player may be permitted to engage in a wide variety of other activities relating to their account. As one aspect of “redeeming” points, a player may be permitted to convert their accumulated points into other types of points, including points or credits which are recognized by other entities as establishing entitlement to a reward. For example, a player may be permitted to redeem points for airline miles to be used towards flight tickets, upgrades and the like. The points may be redeemed for credits which may be used like money as payment for services or goods, such as credits which are honored by the casino or other entities for the purchase of products or services.

Information which is provided to the player may be arranged in a variety of fashions. For example, a players point totals may be illustrated graphically. The player's point totals as compared to prize levels may also be illustrated graphically. Graphical data may also be provided regarding a player's play history, such as points awarded per month over the course of a year.

One or more embodiments of the invention comprise methods for permitting a player to access a player account, to establish an account, to manage an account, and to engage in other account related activities. In one embodiment, the method comprises establishing a communication link from the player to the player tracking system 22 or other account transaction effecting location. In the embodiment illustrated in FIG. 1, in one arrangement this may comprise a player utilizing the remote player device 30 to access the Internet 34. In one embodiment, the player establishes a communication link directly with the player tracking system 22. As noted, the player tracking system 22 preferably includes a communication interface for establishing a two-way communication path thereto, such as via the Internet 34. In one embodiment, the player tracking system 22 may include a data server serving as a hub for receiving and transmitting data. The server preferably has an address and associated domain name which allows a player may establish a communication link from their device 30 via the Internet 34 with the server.

Once the player has established a communication link with the player tracking system 22, the player tracking system 22 may send information, such as information causing the display of a graphical user interface at the player's device 30. In one embodiment, this information may include a “login” screen which instructs a player to provide identification information in order to access their account. This information may comprise the player's name, address, social security number, a previously assigned player identification code, a password or other information. The provided information is transmitted by the player to the player tracking station 22. Once the identity of the player and their entitlement to access account information is established, the player tracking system 22 may send menu information allowing a player to engage in a variety of activities.

In one embodiment, when a new player wishes to establish an account, the “login” screen may instruct a new player to identify themselves as a “guest” or the like. So identified, the player tracking system 22 may then provide an account enrollment form or other guest options.

As another aspect of the invention, and as also illustrated in FIG. 1, the player account access and management system 20 may also be adapted, or instead be adapted, to permit a player to access and manage account information from a player access station 38. Preferably, the player access station 38 is a computing device where player account information is stored separate from the database 26 associated with the computing device of the player tracking system 22.

The player access station 38 may comprise a wide variety of devices or combinations of devices. The player access station 38 in one embodiment includes a computing device including a processor and a memory. In one embodiment, the memory is a data mass storage device.

Preferably, the player access station 38 also includes a communication interface. As with the communication interface of the player remote device 30 and player tracking system 2, the interface may have a variety of architectures and implement one or more of a variety of communication protocols. In one or more embodiments, the communications interface of the player access station 38 permits data communication to and from the station 3 8 from the outside via at least one network link. As illustrated, one such network link 40 preferably provides a connection to an ISP or otherwise to the Internet 34. In addition, one such network link 42 may comprise a connection to a local area network or LAN including the player tracking system.

In general, the player access station 38 is adapted to permit a player to access player account data, manage data and engage in a variety of other functions in similar fashion to that described above where such occurs by direct access to the player tracking system 22. In this embodiment, however, the player tracking system 22 is isolated from access by a player. Instead, the necessary information and functions are implemented via the player access station 38.

In general, in this embodiment of the invention, player account data is arranged to be provided to the player access station 38 from the player tracking system 22. As illustrated, the information may be transmitted over the network link 42. In one embodiment, the information is transmitted through a dedicated line, such as part of a LAN, thus avoiding the transmission of the data in a manner whereby it may be intercepted by third parties. Alternatively, the data may be transmitted via the Internet 34. In one or more embodiments, the player account information may be uploaded to the player access station 38 periodically, such as each day. In another embodiment, the information may be uploaded upon demand, such as when a request for the information is received from a player. In either event, this information is stored at least temporarily at the player access station 38.

Preferably, a player is permitted to engage in the same or similar activities to those described above in the embodiment where the player directly interfaces with the player tracking system 22. In accordance with this alternate embodiment, instead of establishing a communication link directly with the player tracking system 22, the player establishes a communication link with the player access station 38. Again, the player access station 38 may include a communication interface or server having an address and related domain name. Using the address or domain name, the player may access the player access station 38 via the Internet 34. For example, in this illustrated embodiment in FIG. 1, the player access station 38 may have a domain name www.ezcasinocentral.com. By inputting this address into a browser, the player establishes a communication link with the station 38, as is well known.

Preferably, activities of a player with respect to an account (including modifying an existing account and setting up new accounts) are reflected at the player access station 38. In addition, these activities are also reflected at the player tracking system 22. In one embodiment, when a player engages in account-related activities at the player access station 38, activity information is transmitted either at the same time or periodically, to the player tracking system 22. In this manner, the player's account information stored at the database 26 may be updated. In another embodiment, where the player account information is not also stored at the player access system 38, when a player engages in an account-related activity, the player access system 38 may send the account activity request directly to the player tracking system 22 to be executed. For example, the player access system 38 may simply display a player's accumulated points. When a player wishes to redeem points for a prize, then the player access system 38 may simply forward the request to the player tracking system 22 for execution, including awarding the prize and reducing the player's accumulated point total in their file in the database 26. The player tracking system 22 may then forward information regarding the prize award and an updated point total to the player access station 38.

In one or more embodiments, the player access station 38 may include one or more input/output devices by which a player may directly access information. For example, the player access station 38 may include input/output stations, such as located directly at a casino where a player may travel and obtain the desired information or manage their account.

Another embodiment of the invention is illustrated in FIG. 2. This embodiment of the invention is similar to that illustrated in FIG. 1, except that the player account access and management system 120 includes a plurality of player tracking systems 122a,b,c,d. In one embodiment, each of the player tracking systems 122a,b,c,d is associated with a different entity, such as a different casino or gaming property. In this embodiment, the system 120 again includes at least one player access station 138. The player access station 138 functions as a hub or gateway for accessing information regarding any of a player's accounts associated with the various casinos or entities.

Preferably, the operation of this system 120 is similar to the system 20 described above. In accordance with this embodiment, however, a player is permitted to obtain account information regarding accounts associated with more than one entity via a single location. In one embodiment, the player access station 138 is adapted to generate a unified set of information for displaying information regarding all accounts to the player at the same time. For example, the player access station 138 may generate a graph illustrating the player's point totals for each of the player's accounts. In this manner, a player may see which of his accounts have the highest number of accumulated points or which accounts have sufficient points to entitle him to an award. The player may utilize this information in making play decisions. For example, a player seeing that he is only a few points away from an award at one casino may play at that casino the next time he wishes to play instead of another casino where a substantial number of points are necessary to be entitled to a prize.

The information may also include incentives from the various casinos or other entities. For example, the casino may indicate that if a player plays a game at their property within the next day, that player will be awarded a bonus number of points. Upon receiving this information and comparing it to the other casino information, which may not indicate a special point award, the player may make an informed decision to play at the casino offering the bonus points.

In one embodiment, a player may be permitted to pool points from more than one account, move points to other accounts or change the form of the points. In one embodiment, a player is permitted to pool points from more than one account associated with different properties or entities. These pooled points allow a player to reach a higher point total for receiving a reward. Similarly, a player may be permitted to move points from one account to another, thereby increasing the number of points associated with a particular account. In another embodiment, a player may be permitted to change the form of their points. As detailed above, in one embodiment one or more of the player accounts may be of a different form than another. For example, one player account may be associated with an airline and revolve around accumulated “miles” of travel, while another account may track “points” associated with expenditures. In one embodiment, a player is permitted to change points into miles, miles into points and the like. Of course, in such embodiments, agreements may be made between the entities which addresses the movement of these credits (such as miles or points) relative to issued awards.

It will be appreciated that a wide variety of software and hardware may be utilized to implement the invention. For example, the database 26 may be implemented using SQL Server 2000 and be accessed using tools such as XML. A variety of protocols may be utilized for data transmission via the Internet.

As another aspect of the invention, a variety of information may be provided to a player using the system of the invention. In one embodiment, custom messages may be generated for a player which are distributed to the player when they access their account. For example, the player tracking system 22 may determine that a player has qualified for a particular prize or prize level. A message to this effect may be generated and be displayed to the player when they access their account. Likewise, other information or content may be provided to the player, such as specifically targeted advertising. For example, the player tracking system 22 may identify that a player likes to play a particular game based upon the number of points the player is generated by playing the game. Advertising regarding the game, such as a free game offer or the like may be transmitted directly to the player.

As one aspect of the invention, the player tracking system 22 or player access station 38 may be arranged to send information to the player without the player having to access the system 22 or station 38. In one embodiment, the player tracking system 22 and/or player access station 38 is arranged to generate electronic mail (email) messages which are directed to an email account of the player. When the player checks their email, the messages are received. The messages may contain information regarding the player's account, prizes, advertisements and the like. Preferably, these messages are generated based upon the player's account information, such as play information, demographics, accumulated points and the like. In one embodiment, a player may enroll in an “email” service by which the player is provided regular account information updates by email. For example, a player may request end-of-week emails providing up to date point total information.

It will be appreciated that a wide variety of criteria may be used to determine entitlement to an award. In the above-described embodiment, accumulated or awarded points are used. It will be appreciated that other criteria may be used, such as credits, miles or the like which establish entitlement to a reward. The criteria may or may not be associated directly with a player's activities, such as miles of flight or dollars bet.

It will also be appreciated that by the terms “reward,” “award” and the like it is meant something which the player is provided with. In general, the reward or award comprises something of value, whether a service, good or item(s) which may be exchanged for goods or services. These things may include tangible goods, money, credits, and free or reduced cost goods and services. It will be understood that the above described arrangements of apparatus and the method therefrom are merely illustrative of applications of the principles of this invention and many other embodiments and modifications may be made without departing from the spirit and scope of the invention as defined in the claims.

I claim:

1. A player account access and management system comprising:
a player tracking system, said system including at least one gaming device arranged to generate player activity information and a computing device, said computing device including a database, said computing device adapted to receive said player activity information and associate player point information with a player account stored at said database;
a remote device, said device adapted to receive input and display output; and
at least one communication link between said computing device of said player tracking system and said remote device by which information regarding said player account information may be provided to a user of said remote device.

2. The player account access and management system in accordance with claim 1 wherein said communication link includes the Internet.

3. The player account access and management system in accordance with claim 1 wherein said player activity information comprises a number of points assigned to said player as a result of said player's activities at said gaming machine.

4. The player account access and management system in accordance with claim 1 wherein said at least one gaming device is configured to accept a wager, present a game to a player, said game having a winning or losing outcome.

5. The player account access and management system in accordance with claim 1 including a communication interface permitting data to be transmitted to and from said computing device and said remote device via said communication link.

6. A system permitting a player to access information regarding a player account associated with a gaming system comprising:
a first gaming system including a plurality of gaming devices having player tracking devices associated therewith, said player tracking devices adapted to generate player play information, said first gaming system including at least one player tracking host, said player tracking devices associated with said gaming machines arranged to transmit player play information to said player tracking host, said player tracking host configured to store player point information in at least one database;
a second gaming system including a plurality of gaming devices having player tracking devices associated therewith, said player tracking devices adapted to generate player play information, said second gaming system including at least one player tracking host, said player tracking devices associated with said gaming machines arranged to transmit player play information to said player tracking host, said player tracking host configured to store player point information in at least one database; and
a least one gateway, said gateway linked to said at least one player tracking host of said first gaming system and said at least one player tracking host of said second gaming system; and
at least one communication interface, said communication interface permitting a user at a remote device to access said gateway via a communication link and obtain player point information associated with said at least one player tracking host of said first gaming system and said at least one player tracking host of said second gaming system.

7. The system in accordance with claim 6 including at least one communication link between said gateway and said at least one player tracking host of said first gaming system and at least one communication link between said gateway and said at least one player tracking host of said second gaming system.

8. The system in accordance with claim 6 wherein said gateway includes a memory adapted to store player point information received from said at least one player tracking host of said first gaming system and at least one player tracking host of said second gaming system.

9. The system in accordance with claim 6 wherein said plurality of said gaming machines of said first gaming system are located at different geographic locations than said plurality of gaming machines of said second gaming system.

10. The system in accordance with claim 6 wherein said player tracking devices include a card reader adapted to read player information and are adapted to generate point information relating to player play activity at the related gaming machine.

11. A method of permitting a player of one or more gaming machines to access a player account comprising:
establishing a communication link between a remote device and a player tracking host of a player tracking system;
generating player account information; and
transmitting player account information over said communication link from said player tracking host to said player at said remote device.

12. The method in accordance with claim 11 including the steps of generating player point information in response to player game play at said one or more gaming machines, transmitting said player point information to said player tracking host, and storing said player point information in a player account file, and wherein said step of generating comprises generating a player point total from said player point information at said player account file.

13. The method in accordance with claim 11 wherein said player account information comprises player points, and including the step of receiving a request from said player at said remote device to redeem one or more player points for an award.

14. The method in accordance with claim 11 wherein said player account information comprises player points, and including the step of receiving a request from said player at said remote device to convert one or more player points to another form.

15. A method of permitting a player of one or more gaming machines to access and manipulate player account information comprising:
generating player game play information regarding a player's play of one or more gaming machines of a first gaming machine network;
generating player game play information regarding a player's play of one or more gaming machines of a second gaming machine network;
establishing a communication link between a remote device and a player account access device;
obtaining player game play information associated with either or both said first gaming machine network and second gaming machine network; and
transmitting player game play information over said communication link from said player tracking host to said player at said remote device.

16. The method in accordance with claim 15 including the step of storing said player game play information regarding a player's play of one or more gaming machines of said first gaming machine network at a first player tracking host and the step of storing said player game play information regarding a player's play of one or more gaming machines of said second gaming machine network at a second player tracking host, and wherein said obtaining step comprises transmitting player game play information from said first and second player tracking host to said player account access device.

17. The method in accordance with claim 15 wherein said player game play information regarding a player's play of one or more gaming machines of said first gaming machine network comprises a number of first gaming machine network player points and wherein said player game play information regarding a player's play of one or more gaming machines of said second gaming machine network comprises a number of second gaming machine network player points.

18. The method in accordance with claim 17 including the step of storing information regarding said first gaming machine network player points at a first player tracking host of said first gaming machine network and storing information regarding said second gaming machine network player points at a second player tracking host of said second gaming machine network.

19. The method in accordance with claim 18 including the step of transferring player points from one player tracking host to another, decreasing a number of player point at one host and increasing a number at the other host.

20. The method in accordance with claim 15 including the step of storing said generated player game play information at said player account access device.
